(19) United States
(12) Patent Application Publication
(10) Pub. No.: US 2025/0379836 A1
(43) Pub. Date: Dec. 11, 2025

(54) ARTIFICIAL INTELLIGENCE-BASED MESSAGE GENERATION DEVICE AND METHOD

(71) Applicants: Jae Ho CHOI, Seoul (KR); Seo Hyun CHOI, Seoul (KR); Delta PDS CO., LTD., Seoul (KR)

(72) Inventors: Jae Ho CHOI, Seoul (KR); Seo Hyun CHOI, Seoul (KR)

(73) Assignees: Jae Ho CHOI, Seoul (KR); Seo Hyun CHOI, Seoul (KR); Delta PDS CO., LTD., Seoul (KR)

(21) Appl. No.: 19/220,315

(22) Filed: May 28, 2025

(30) Foreign Application Priority Data
Jun. 7, 2024 (KR) 10-2024-0074511

(51) Int. Cl. H04L 51/04; G10L 15/26; G10L 17/00; H04L 51/212

(52) U.S. Cl. CPC H04L 51/04; G10L 15/26; G10L 17/00; H04L 51/212

(57) ABSTRACT

A message generation device method based on artificial intelligence are disclosed. The message generation device includes a memory and a processor electrically connected to the memory, wherein the processor is configured to receive selection of a user for a chat room from a user terminal, receive a voice file of the user recorded on the user terminal, recognize a voice of the voice file and generate a script converted into text and a summary message, and display the summary message as a conversation message in the chat room associated with the selection of the user.

### CROSS-REFERENCE TO RELATED PATENT APPLICATION

This application claims the benefit of Korean Patent Application No. 10-2024-0074511, filed on Jun. 7, 2024, in the Korean Intellectual Property Office, the disclosure of which is incorporated herein in its entirety by reference.

### TECHNICAL FIELD

The present disclosure relates to an artificial intelligence message providing technology, and more specifically, to a technology by which the voice of a user participating in a chat room is recorded, summarized into a message through artificial intelligence, and then shared in the chat room to be delivered to other users.

### BACKGROUND

In general, an Internet messenger is an application that delivers messages including text or graphics between users and can be implemented as a chat room in which multiple users participate. An Internet messenger may include a mobile messenger that is executed in a mobile environment such as a smartphone. For example, mobile messengers may include messengers such as KakaoTalk, Line, WeChat, and Facebook. In particular, Internet messengers have recently been increasingly utilized in various ways in managing and progressing work.

In particular, as the scale of projects gradually increases and the structure of projects becomes more complex, the number of chat rooms in which work participants participate simultaneously within a single project is also increasing. It may be difficult for work participants to easily understand the flow of related work in a communication process that is carried out in a distributed manner through multiple chat rooms.

Accordingly, various tools are being developed to support communication between various participants participating in a project. For example, minutes of a meeting between participants are used to summarize the contents of the meeting, store the summarized contents, and share the same with users to easily share the progress.

Nevertheless, in addition to writing standardized documents such as minutes, considerable effort and time are required to effectively document or record unstandardized contents such as verbal instructions, and thus technology for improving work efficiency is required.

### PRIOR ART DOCUMENT

### Patent Document

Korean Patent Publication No. 10-2018-0058415 (2018.06.01)

### SUMMARY

One aspect of the present disclosure provides an artificial intelligence-based message generation device and method for recording the voice of a user participating in a chat room, summarizing the voice into a message through artificial intelligence, and then sharing the message in the chat room to deliver the same to other users.

In embodiments, a message generation device based on artificial intelligence includes a memory and a processor electrically connected to the memory, wherein the processor is configured to receive selection of a user for a chat room from a user terminal, receive a voice file of the user recorded on the user terminal, recognize a voice of the voice file and generate a script converted into text and a summary message, and display the summary message as a conversation message of the chat room associated with the selection of the user.

The processor may be configured to receive a voice of the user input in a streaming manner from the user terminal in real time and generate the voice file.

The processor may be configured to generate the script by applying a Speech-To-Text (STT) algorithm to the voice file and generate the summary message by inputting the script to an artificial intelligence model constructed in advance.

The processor may be configured to generate the script and the summary message by inputting the voice file to an artificial intelligence model constructed in advance.

The artificial intelligence model may be constructed by being trained to receive the voice file as input and generate at least one of the script or the summary message as output. The processor may be configured to display an interface associated with the conversation message based on reception of selection for the conversation message from a chat room participant of the chat room.

The processor may be configured to provide at least one of a plurality of functions including viewing a script, listening to a voice file, and creating a task associated with the conversation message through the interface.

The processor may be configured to, in a case where a task associated with the conversation message is generated through the interface, calculate a statistical value associated with the task and update the conversation message by adding the statistical value to the conversation message.

The processor may be configured to identify a conversational tone of the voice in the process of recognizing the voice, and convert the summary message into a conversation message to which the conversational tone has been applied in the process of displaying the summary message as the conversation message.

The processor may be configured to generate at least one of the script or the summary message by applying the conversational tone of the voice identified in the process of recognizing the voice.

The processor may be configured to update at least one of conversation messages displayed in the chat room with the conversational tone set by the user and display the updated conversation message.

The processor may be configured to generate a tag associated with the summary message, combine the tag with the summary message, and provide a search function for the summary message through the tag.

The processor may be configured to selectively provide a message translation function in a process of providing details of the summary message.

The processor may be configured to recommend one or more recommended tasks related to the summary message or the conversation message through a task recommendation model, and generate a task related to a recommended task selected by the user from among the one or more recommended tasks.

The processor may be configured to determine a work relevance regarding whether the summary message or the conversation message is related to details of work, and generate a recommended task related to the details of work based on the work relevance exceeding a preset threshold value.

The processor may be configured to, during a process of providing at least one of a voice file, a script, or a summary message related to the conversation message through a detailed view page for the conversation message, block other users from viewing the voice file, the script, or the summary message according to privacy setting set by the user.

The processor may be configured to perform an operation of regenerating the summary message depending on the length of the summary message.

The processor may be configured to assign a favorites function to each conversation message and store the conversation message, and provide a list of conversation messages to which the favorite function has been assigned through a favorites page.

The processor may be configured to assign a status value indicating a specific status to each conversation message and store the conversation message to which the status value has been assigned.

In embodiments, a message generation method based on artificial intelligence is performed in a message generation device including a memory and a processor electrically connected to the memory. The method is performed by the processor and includes receiving selection of a user for a chat room from a user terminal, receiving a voice file of the user recorded on the user terminal, recognizing a voice of the voice file and generating a script converted into text and a summary message, and displaying the summary message as a conversation message of the chat room associated with the selection of the user.

### Advantageous Effects

The disclosed technology has the following effects. However, it does not mean that a specific embodiment must include all or only the following effects, and therefore, the scope of the disclosed technology should not be understood as being limited thereby.

According to one embodiment of the present disclosure, an artificial intelligence-based message generation device and method can record the voice of a user participating in a chat room, summarize the voice into a message through artificial intelligence, and then share the message in the chat room to deliver the same to other users.

### BRIEF DESCRIPTION OF THE DRAWINGS

FIG. 1 is a diagram illustrating a message generation system according to the present disclosure.

FIG. 2 is a diagram illustrating a system configuration of a message generation device of FIG. 1.

FIG. 3 is a diagram illustrating a functional configuration of the message generation device of FIG. 1.

FIG. 4 is a flowchart illustrating an artificial intelligence-based message generation method according to the present disclosure.

FIG. 5 is a diagram illustrating an embodiment of a conversation message generation process according to the present disclosure.

FIG. 6 is a diagram illustrating an embodiment of a task creation process according to the present disclosure.

FIG. 7 is a diagram illustrating an embodiment of a process of providing related functions in a chat room according to the present disclosure.

FIG. 8 is a diagram illustrating a process of sharing a conversation message regarding user's voice within a chat room according to the present disclosure.

FIG. 9 is a diagram illustrating an embodiment of a detailed view page of a conversation message according to the present disclosure.

### DETAILED DESCRIPTION

A description of the present disclosure is merely an embodiment for a structural or functional description and the scope of the present disclosure should not be construed as being limited by an embodiment described in a text. That is, since the embodiment can be variously changed and have various forms, the scope of the present disclosure should be understood to include equivalents capable of realizing the technical spirit. Further, it should be understood that since a specific embodiment should include all objects or effects or include only the effect, the scope of the present disclosure is limited by the object or effect.

Meanwhile, meanings of terms described in the present application should be understood as follows.

The terms “first,” “second,” and the like are used to differentiate a certain component from other components, but the scope of should not be construed to be limited by the terms. For example, a first component may be referred to as a second component, and similarly, the second component may be referred to as the first component.

It should be understood that, when it is described that a component is “connected to” another component, the component may be directly connected to another component or a third component may be present therebetween. In contrast, it should be understood that, when it is described that an element is “directly connected to” another element, it is understood that no element is present between the element and another element. Meanwhile, other expressions describing the relationship of the components, that is, expressions such as “between” and “directly between” or “adjacent to” and “directly adjacent to” should be similarly interpreted.

It is to be understood that the singular expression encompasses a plurality of expressions unless the context clearly dictates otherwise and it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

In each step, reference numerals (e.g., a, b, c, etc.) are used for convenience of description, the reference numerals are not used to describe the order of the steps and unless otherwise stated, it may occur differently from the order specified. That is, the respective steps may be performed similarly to the specified order, performed substantially simultaneously, and performed in an opposite order.

The present disclosure can be implemented as a computer-readable code on a computer-readable recording medium and the computer-readable recording medium includes all types of recording devices for storing data that can be read by a computer system. Examples of the computer readable recording medium may include a ROM, a RAM, a CD-ROM, a magnetic tape, a floppy disk, an optical data storage device, and the like. Further, the computer readable recording media may be stored and executed as codes which may be distributed in the computer system connected through a network and read by a computer in a distribution method.

If it is not contrarily defined, all terms used herein have the same meanings as those generally understood by those skilled in the art. Terms which are defined in a generally used dictionary should be interpreted to have the same meanings as the meanings in the context of the related art, and are not interpreted as ideal meanings or excessively formal meanings unless clearly defined in the present application.

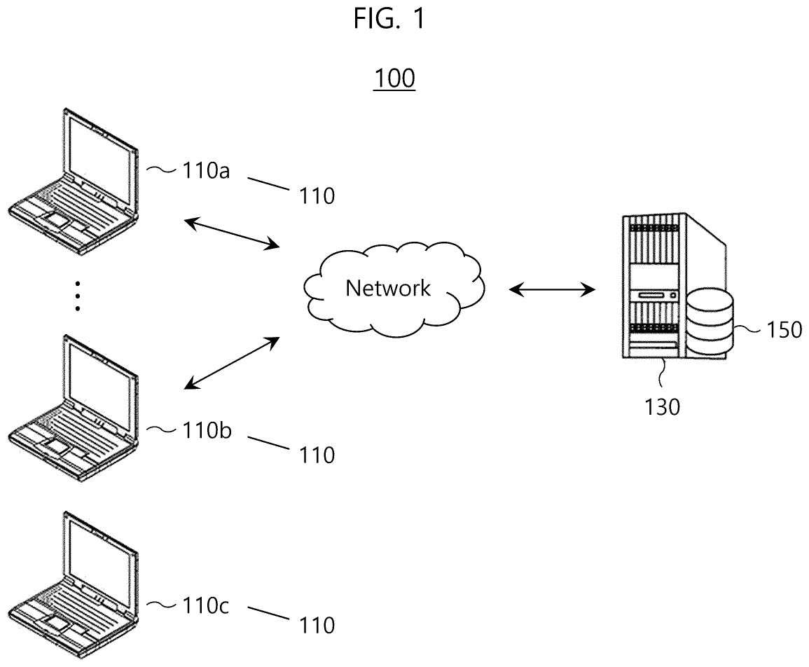

FIG. 1 is a diagram illustrating a message generation system according to the present disclosure.

Referring to FIG. 1, the message generation system 100 may include a plurality of user terminals 110, a message generation device 130, and a database 150.

The user terminal 110 may be a computing device operated by a user. For example, the user terminal 110 may be implemented as a desktop computer, a laptop computer, a tablet PC, or a smart phone, but is not necessarily limited thereto and may be implemented as various devices.

There may be one or more user terminals 110, and in this case, the user terminal 110 may include one or more of first, second, and third user terminals 110a, 110b, and 110c. For convenience, the user terminal 110 used by a first user may be referred to as the first user terminal 110a, the user terminal 110 used by a second user may be referred to as the second user terminal 110b, and the user terminal 110 used by a third user may be referred to as the third user terminal 110c.

In the embodiment of the present disclosure, a plurality of users may be included in one or more user groups. The one or more user groups may be referred to as a first user group, a second user group, and a third user group. One user may be included in one or more user groups at the same time.

In addition, a plurality of users may be work participants participating in a common project or work. For example, work participants may include a work instructor who instructs work, a work performer who performs work, and a work-related person who is related to work.

In this case, one overall project may be present, and the overall project may include a plurality of work projects that are independently performed. In addition, a plan, a card, a note, or a task may be created and stored in association with the overall project or a work project.

Here, a plan may be a work plan established to achieve a specific goal, a card may be a management card regarding a series of tasks, a note may be a work record that stores contents related to work, and a task may be related to various unit tasks that are generated and processed according to a plan, a card, or a note.

In addition, during the process of processing a plan, a card, a note, or a task, objects such as messages, files, and photos (or videos) may be shared between users, and a chat room may be provided for conversations and object sharing between users. In this case, messages shared through the chat room may include conversation messages regarding daily contents and work messages regarding details of work. Here, conversation messages and work messages are described separately, but it is obvious that each message may include daily contents or details of work.

In one embodiment, at least one of the user terminals 110 may be a mobile terminal and may be connected to the message generation device 130 via cellular communication or Wi-Fi communication. In another embodiment, at least one of the user terminals 110 may be a desktop computer and may be connected to the message generation device 130 via the Internet.

The message generation device 130 may be a computing device that may be connected to at least one user terminal 110 via a network. In one embodiment, the message generation device 130 may manage one or more user groups in which other users associated with one user are included as members, i.e., work participants.

In one embodiment, the message generation device 130 may be connected to the user terminal 110 via a dedicated agent installed in the user terminal 110. Here, the dedicated agent may be an agent program, which is software that, when installed in the user terminal 110, enables the user terminal 110 and the message generation device 130 to be mutually interconnected under the approval of the user terminal 110.

The connection and combination between the message generation device 130 and the user terminal 110 described herein may be an embodiment, and may be applied in various forms within a typical range according to various operations and implementation environments.

In one embodiment, the message generation device 130 may include an artificial intelligence model inside in order to perform an artificial intelligence-based message generation method according to the present disclosure. Accordingly, an on-device AI may be applied to the message generation device 130, and the message generation device 130 may perform related operations using the artificial intelligence model even when the device is not connected to a network.

The database 150 may be a storage device in which various types of information required during the operation of the message generation device 130 are stored. For example, the database 150 may store a voice file in which user's voice is recorded, may store a script and a summary message extracted from a voice file, or may store information on an artificial intelligence model for voice recognition and text summarization. However, the database 150 is not necessarily limited thereto, and may store information collected or processed in various forms during the process in which the message generation device 130 performs the artificial intelligence-based message generation method according to the present disclosure.

Although the database 150 is illustrated as a logical storage device included in the message generation device 130 in FIG. 1, the present disclosure is not necessarily limited thereto, and it is obvious that the database 150 may be implemented as a device independent of the message generation device 130.

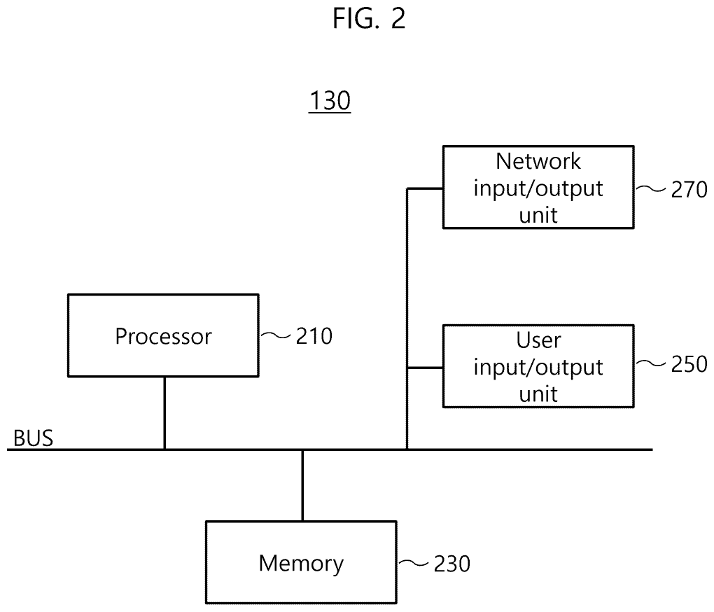

FIG. 2 is a diagram illustrating a system configuration of the message generation device of FIG. 1.

Referring to FIG. 2, the message generation device 130 may include a processor 210, a memory 230, a user input/output unit 250, and a network input/output unit 270.

The processor 210 may execute an artificial intelligence-based message generation procedure according to the present disclosure, manage the memory 230 from/to which information is read/written during the procedure, and schedule a synchronization time between a volatile memory and a non-volatile memory in the memory 230.

The processor 210 may control the overall operation of the message generation device 130 and may be electrically connected to the memory 230, the user input/output unit 250, and the network input/output unit 270 to control a data flow therebetween. The processor 210 may be implemented as a central processing unit (CPU) or a graphics processing unit (GPU) of the message generation device 130.

The memory 230 may include an auxiliary memory device implemented as a nonvolatile memory such as a solid state drive (SSD) or a hard disk drive (HDD) and used to store all data required for the message generation device 130, and may include a main memory device implemented as a volatile memory such as a random access memory (RAM). In this way, the memory 230 may be implemented as a volatile memory and a nonvolatile memory, and if implemented as a nonvolatile memory, may be connected through a hyperlink.

The user input/output unit 250 includes an environment for receiving user input and an environment for outputting specific information to a user, and may include, for example, an input device including or connected to an adapter such as a mouse, a trackball, a touch pad, a graphic tablet, a scanner, a touch screen, a keyboard, or a pointing device, and an output device including an adapter such as a monitor or a touch screen. In one embodiment, the user input/output unit 250 may be a computing device that is accessed through remote access, and in such a case, the message generation device 130 may serve as a server.

The network input/output unit 270 provides a communication environment for connecting to the user terminal 110 through a network, and may include, for example, an adapter for communication, such as a Local Area Network (LAN), a Metropolitan Area Network (MAN), a Wide Area Network (WAN), and a Value Added Network (VAN). The network input/output unit 270 may be configured to provide a short-distance communication function such as Wi-Fi or Bluetooth or a wireless communication function of 4G or higher for wireless transmission of data.

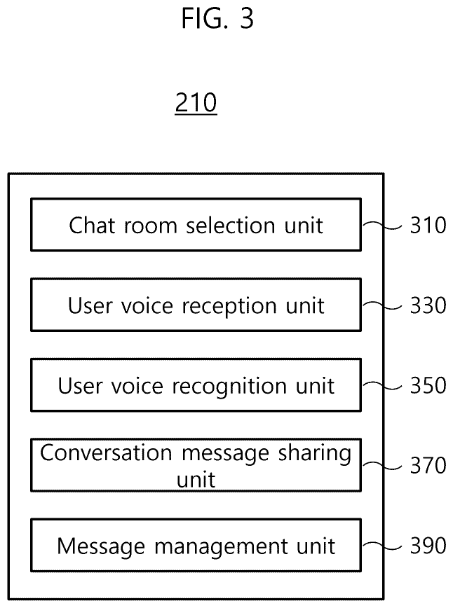

FIG. 3 is a diagram illustrating the functional configuration of the message generation device of FIG. 1.

Referring to FIG. 3, the message generation device 130 may perform the artificial intelligence-based message generation method according to the present disclosure. To this end, the message generation device 130 may include a chat room selection unit 310, a user voice reception unit 330, a user voice recognition unit 350, a conversation message sharing unit 370, and a message management unit 390.

The embodiment of the present disclosure does not have to include all of the above components at the same time, and some of the above components may be omitted or some or all of the above components may be selectively included in the message generation device 130 according to each embodiment. The operation of each component will be described in detail below.

The chat room selection unit 310 may receive user's selection for a chat room from the user terminal 110. That is, the user can check a list of chat rooms in which the user is participating on the user terminal 110 and select a specific chat room in the list. The chat room selection unit 310 may operate in connection with the user terminal 110, receive user's selection for a chat room, and perform operations related to the selected chat room in a subsequent operation process.

In an embodiment, the chat room selection unit 310 may receive a search key including a keyword from the user terminal 110 and determine that user's selection has been input for one of the chat rooms searched based on the search key. Basically, the user may select the chat room within the chat rooms in which the user is participating, and may select a chat room in various ways from outside the chat room as needed. In addition, if the user is participating in multiple chat rooms, the user may input a keyword associated with the chat room, and the chat room selection unit 310 may receive the keyword input by the user from the user terminal 110 and search chat rooms associated with the user based on the keyword. For example, the keyword may include the user's name or ID, or a word related to details of work. If there is only one chat room searched, the chat room selection unit 310 may determine that the user's selection has been input for the chat room, and if there are multiple chat rooms searched, the chat room selection unit 310 may determine that the user's selection has been input for some of the multiple chat rooms.

The user voice reception unit 330 may receive a voice file of the user recorded on the user terminal 110. That is, the user voice reception unit 330 may receive a voice file transmitted from the user terminal 110 and store the same in the database 150. The user may directly record a voice through the user terminal 110 to create a voice file, and may select one of various voice files stored in the user terminal 110.

In an embodiment, the user voice reception unit 330 may receive user's voice input in a streaming manner from the user terminal 110 in real time to create a voice file. That is, the user may directly record his/her voice on the user terminal 110 having a voice recording function, such as a smartphone, a tablet, or a PC, and the user voice reception unit 330 may receive the user's voice recorded in real time in a streaming manner in connection with the user terminal 110 and create a file in an audio data format such as WAV or MP3. The user voice reception unit 330 may compress voice data received in real time to save storage space for voice files, and determine a compression method in consideration of network conditions, etc.

The user voice recognition unit 350 may recognize the voice of a voice file and generate a script converted into text and a summary message. To this end, the user voice recognition unit 350 may perform an operation of analyzing voice data stored in a voice file using various voice recognition algorithms and then converting the same into text. For example, the voice recognition process may include a voice analysis process of decomposing a voice signal into elements such as frequency and intensity, a voice interpretation process of interpreting the voice signal using a trained model, and a voice conversion process of converting phonemes extracted through the model into text. Here, the script may be the result of converting the user's voice stored in the voice file into text, and the summary message may be the result of concisely summarizing the core contents of the script.

Therefore, the script and the summary message may be expressed as data in the form of text, and may be stored and managed in association with the user or voice file. For example, voice files associated with a specific user may be selectively searched, or a script or summary messages associated with a specific voice file may be selectively searched.

In an embodiment, the user voice recognition unit 350 may generate the script by applying a Speech-To-Text (STT) algorithm to the voice file and generate the summary message by inputting the script to an artificial intelligence model constructed in advance. Here, the STT algorithm may be an algorithm for converting a voice signal into text and may support various languages. The artificial intelligence model may be a model that summarizes the core contents of input data in the form of text through data learning based on machine learning or deep learning to generate output data in the form of text. The user voice recognition unit 350 may accurately and efficiently generate the script and the summary message in connection with the STT algorithm and the artificial intelligence model.

In an embodiment, the user voice recognition unit 350 may transmit a voice file to an external STT server and receive a script from the STT server. For example, the external STT server may include a CLOVA speech server, a Whisper server that supports multilingual speech recognition, etc. That is, the user voice recognition unit 350 may generate a text-type script regarding user's voice stored in a voice file through an external STT server that provides an automatic speech recognition (ASR) service.

In an embodiment, the user voice recognition unit 350 may transmit a voice file to a plurality of STT servers and select one of text received from the STT servers as a script. That is, since the user voice recognition unit 350 can utilize an external STT service instead of an internal STT algorithm, the user voice recognition unit 350 may selectively apply a more suitable result among the text converted by one or more STT servers and allow the next step operation to be performed based thereon. For example, the user voice recognition unit 350 may receive a script from an STT server sequentially selected from among a plurality of STT servers or may selectively receive a script from the most popular STT server among the STT servers. In addition, the user voice recognition unit 350 may operate using various selection methods to receive a script from among the STT servers.

In an embodiment, the user voice recognition unit 350 may input a voice file to an artificial intelligence model constructed in advance to generate a script and a summary message. The user voice recognition unit 350 may generate both a script and a summary message from a voice file using only an artificial intelligence model. To this end, the artificial intelligence model may be trained and constructed to receive a voice file as input data and generate output data including a script and a summary message. In this case, the artificial intelligence model may be implemented as a single model, and may include a plurality of sub-models as needed. For example, the artificial intelligence model may include a first model that generates a script from a voice file and a second model that generates a summary message from the script, and may be implemented in a structure in which the output of the first model is connected to the input of the second model.

In an embodiment, the artificial intelligence model may be trained to receive a voice file as input and generate at least one of a script and a summary message as output. For example, the artificial intelligence model may be constructed as a model that receives a voice file as input and generates a script as output. The artificial intelligence model may be constructed as a model that receives a voice file as input and generates a summary message as output. The artificial intelligence model may be constructed as a model that receives a voice file as input and generates a script and a summary message as output. In addition, the artificial intelligence model may be constructed to support various forms of input and output.

The conversation message sharing unit 370 may display a summary message as a conversation message in a chat room associated with user's selection. That is, the conversation message sharing unit 370 may share a summary message generated by summarizing a script recognized from user's voice as a conversation message in the chat room in which the user is participating. The conversation message may be defined as a voice memo as a message shared in the chat room. Here, other users participating in the chat room can recognize the conversation message as a message input by the user. Accordingly, the user can easily transmit recorded voice to other users in the chat room through a conversation message (or voice memo) without inputting a separate message in the chat room. The conversation message sharing unit 370 may convert the text of the summary message into a chat message format basically and share the same in the chat room, and may also display images or videos related to the contents of the summary message along with the chat message if necessary.

In an embodiment, the conversation message sharing unit 370 may display an interface related to chat messages upon reception of selection for a chat message from a participant in the chat room. That is, each user participating in the chat room may directly select a shared chat message, and when selection of each user is detected for a chat message, the conversation message sharing unit 370 may provide functions related to the chat message through a separate interface. The interface may basically include basic functions such as message copying, deleting, and sharing.

In an embodiment, the conversation message sharing unit 370 may provide at least one of a plurality of functions including viewing a script, listening to a voice file, and creating a task related to the conversation message through the interface. That is, if a conversation message is a summary message generated from a user's voice file, the conversation message sharing unit 370 may additionally provide functions related to the summary message through the interface. The script viewing function may be a function of providing details of a script related to a summary message, the voice file listening function may be a function of reproducing a voice file related to a summary message, and the task creation function may be a function of creating one or more tasks related to a summary message. The user may select a specific function on the interface and execute an operation for the function.

In an embodiment, when a task associated with a conversation message is created through the interface, the conversation message sharing unit 370 may calculate a statistical value related to the task and may update the conversation message by adding the statistical value thereto. The conversation message sharing unit 370 may cause related functions to be executed according to user's selection on the interface and may determine whether a task associated with a conversation message has been successfully created through the task creation function. Thereafter, the conversation message sharing unit 370 may calculate a statistical value related to the created task when task creation is completed.

For example, the conversation message sharing unit 370 may calculate the number and ratio of tasks in progress or completed, the number and ratio of tasks with an imminent deadline or overdue tasks, and the number of users participating in a task or information on the person in charge as statistical values. The conversation message sharing unit 370 may update the conversation message by adding at least some of the calculated statistical values (e.g., progress, deadline, participants, etc.). Accordingly, users participating in a chat room can rapidly ascertain the progress of work or project related to the concerned chat message and efficiently manage their work.

In an embodiment, the conversation message sharing unit 370 may identify the conversational tone of a voice during the process of recognizing the voice, and convert a summary message into a conversation message to which the conversational tone has been applied during the process of displaying the summary message as a conversation message. Here, the conversational tone may be linguistic characteristics of the user used in a voice conversation situation, and may indicate speaker's emotions, intentions, and relationships. The conversational tone may be determined based on characteristics such as words and expressions used (e.g., informal speech, formal speech, etc.), sentence structure and rules, pronunciation, speed, and intonation. The conversation message sharing unit 370 may extract feature information such as vocabulary, grammar, and voice from text during the process of converting a voice signal into text during voice recognition, and may identify the conversational tone based on the extracted feature information. The process of identifying a conversational tone may be performed through a process of classifying various types of feature information and determining a conversational tone that matches a classification result.

In addition, the conversation message sharing unit 370 may convert a summary message into a conversation message expressed in an identified conversational tone in the process of displaying the summary message as a conversation message. For example, if the identified conversational tone is ‘friendly and comfortable tone’, the conversation message sharing unit 370 may convert the summary message according to the conversational tone to create a conversation message in a comfortable tone such as talking to a friend in a friendly mood. In this case, the conversation message sharing unit 370 may perform a conversation message conversion operation by utilizing a speech conversion model trained to receive the summary message and the conversational tone as input and generate a conversation message expressed in the conversational tone as output.

In an embodiment, the conversation message sharing unit 370 may apply a conversational tone of voice identified in the process of recognizing the voice to generate at least one of a script and a summary message. That is, the conversation message sharing unit 370 may apply an artificial intelligence model in the process of sequentially generating a script and a summary message from a voice file to generate a script and a summary message in a text form from a voice file. In this case, the conversation message sharing unit 370 may receive a script and a summary message to which a specific conversational tone has been applied from the artificial intelligence model.

The conversation message sharing unit 370 may perform an operation of selectively applying a specific conversational tone to an already generated script and summary message to recreate the same, and if the conversational tone of the script and the conversational tone of the summary message are different, the conversational tones of the script and the conversational tone of the summary message may be compared with each other, and then the script and the summary message may be automatically or selectively converted into a specific conversational tone to match the conversational tones of the script and the conversational tone of the summary message as needed.

In an embodiment, the conversation message sharing unit 370 may generate and provide a plurality of conversation messages to which various conversational tones have been applied in the process of displaying the summary message as a conversation message, and may display a conversation message selected by the user from among the plurality of conversation messages through the chat room. The conversation message sharing unit 370 may generate a plurality of conversation messages to which respective conversational tones have been applied using a speech conversion model. The conversation message sharing unit 370 may provide the plurality of conversation messages to the user through a separate interface on the user terminal 110, and the user may select a specific conversation message and display the in the chat room.

In an embodiment, the conversation message sharing unit 370 may update at least one of conversation messages displayed in the chat room with the conversation tone set by the user and display the same. The user may select a conversation message already displayed in the chat room and apply a specific conversation tone thereto, and when the conversation tone is changed by the user, the conversation message sharing unit 370 may convert the conversation message to the changed conversation tone and then update and display the existing conversation message. The user may apply a specific conversation tone to one or more conversation messages such that the conversation messages are updated and displayed simultaneously. In addition, the user may select only conversation messages input during a specific period of time among the conversation messages displayed in the chat room and apply a specific conversation tone thereto.

The message management unit 390 may store summary messages or conversation messages in the database 150 and manage the same. The message management unit 390 may assign a unique identifier to each message to identify the same and may store the date and time when each message has been created, a voice file or script information associated with each message, and the contents (i.e., text) of each message in the database 150 in association with one another. In addition, the message management unit 390 may store and manage additional information such as a tag and a category generated in association with each message. The message management unit 390 may provide functions such as searching, deletion, modification, sorting, and filtering as management functions for managing each message.

In an embodiment, the message management unit 390 may generate a tag associated with each message, combine the tag with the related message, and provide a search function for each message through the tag. The message management unit 390 may analyze the contents of each message to extract core keywords, etc. in order to generate a tag, and perform an operation of generating a related tag based on the extracted information and combining the same with the related message. Types of tags may include a subject tag indicating the subject of each message, an entity tag indicating a person, a place, or an object appearing in each message, a description tag briefly describing the contents of each message, etc. In addition, the message management unit 390 may search for messages with attached tags through tags, and may perform operations of filtering search results using a specific tag, recommending messages based on tags in which a user is interested, and the like.

In an embodiment, the message management unit 390 may optionally provide a message translation function in the process of providing details of a message. The message management unit 390 may provide details of a message through a detailed page regarding the message and may provide a separate independent interface for the detailed page. That is, the message management unit 390 may provide a message translation function as one of various functions within the interface for the detailed page. To this end, the interface may be implemented to operate in connection with a translation engine. By selecting the message translation function, the user can receive a translation regarding a summary message or a conversation message. The message management unit 390 may provide each message and the translation thereof together through the interface and may also display a specific message by replacing the same with a translation.

In an embodiment, when the message management unit 390 receives a request for recommendation of a task with respect to a summary message or a conversation message from the user terminal 110, the massage management unit 390 may create one or more recommended tasks associated with the summary message or the conversation message through a task recommendation model according to the task recommendation request. For example, if a summary message is provided through a dedicated interface on the user terminal 110, the user can activate a function of automatically recommending tasks related to the specific summary message by selecting a task recommendation menu in a state in which the specific summary message has been selected on the dedicated interface. As another example, if a conversation message is selected by the user in a chat room, the task creation function may be provided through an interface, and if the task creation function is selected by the user, the function of automatically recommends tasks related to the conversation message may be activated. The message management unit 390 may receive a signal regarding a task recommendation request from the user terminal 110 and may initiate a response operation upon reception of the task recommendation request.

In addition, the message management unit 390 may create a recommended task through a task recommendation model according to the task recommendation request. Here, the task recommendation model may be an artificial intelligence model that receives text about a summary message or a conversation message as input and generates one or more recommended tasks as output, and may be implemented as a model based on machine learning or deep learning. In addition, the task recommendation model may be constructed in association with a task table that stores recommended tasks, and in this case, the task recommendation model may generate index information of the table as recommended task information. That is, the message management unit 390 may query the task table based on the index information output by the task recommendation model to generate recommended tasks and recommend the same to the user.

In addition, the message management unit 390 may generate a task with related to a recommended task selected by the user from among one or more recommended tasks. That is, the user may select some of the recommended tasks to generate a task, check the details of the generated task, and then perform operations of modifying the task, completing the task, and the like as needed.

In an embodiment, the message management unit 390 may determine work relevance regarding whether a summary message or a conversation message is related to details of work, and may generate recommended tasks regarding the details of work if the work relevance exceeds a preset critical value. Here, the work relevance may be an indicator indicating the relevance between the summary message or conversation message and the details of work. That is, the work relevance may be determined based on whether the subject of the message and the subject of the details of work match, whether the message and the concept used in the details of work match, whether entities such as people, places, and objects appearing in the message and the details of work match, and whether the context of the message and the context of the details of work match.

More specifically, the message management unit 390 may analyze the contents of the summary message or conversation message to extract information regarding the subject, concept, entities, and context, compare the message and the details of work to determine the similarity therebetween based on the extracted information, and then generate an evaluation result. The message management unit 390 may represent the work relevance as a specific score within a specific range based on the comparison and evaluation results. In addition, the message management unit 390 may set a threshold value for the work relevance, and if the calculated work relevance score exceeds the threshold value, generate tasks related to the message, and recommend the same to the user.

In this case, the user may select some of the recommended tasks to create a task, check the details of the created task, and then perform an operation of modifying the task or completing the task as needed. Task information may include a task title, details of a task, start and end dates, a person in charge, and priority.

In addition, the message management unit 390 may determine the priority of a task based on related work relevance scores for the recommended or created tasks. The message management unit 390 may generate a notification regarding the recommended or created tasks and provide the same to the user terminal 110. The message management unit 390 may also adjust the threshold value regarding the work relevance according to user preference.

In an embodiment, the message management unit 390 may block other users from viewing a voice file, a script, or a summary message related to a conversation message according to privacy setting set by the user during the process of providing at least one of the voice file, the script, or the summary message related to the conversation message through the detailed view page for the conversation message. The message management unit 390 may provide a detailed view function for each conversation message that is created in association with a voice file and shared within a chat room, and may provide a detailed view page for displaying the details of the conversation message within the chat room.

For example, user a may share a text-based conversation message through a voice file in which his or her own voice has been recorded through a chat room. In addition, the user may set whether to make public a voice file, a script, or a summary message associated with the conversation message as setting information regarding the conversation message. That is, if user a sets the voice file associated with the conversation message m to private, user a can view all of the voice file, the script, and the summary message, whereas another user b can view only the script and the summary message excluding the voice file that is set to private.

In an embodiment, the message management unit 390 may perform an operation of regenerating a summary message according to the length of the summary message. The message management unit 390 may limit the length of the summary message to a specific length as needed, and if not, a summary message generated according to a script may have various lengths. In this case, if the length of a summary message is excessively long or excessively short, the message management unit 390 may re-perform the process of generating the summary message from the script to regenerate a summary message that is shorter or longer than the existing summary message. The message management unit 390 may provide a generated summary message to the user, and may selectively perform an operation of regenerating a summary message that is longer or shorter than the summary message by receiving user's selection.

In an embodiment, the message management unit 390 may apply and store a favorites function for each conversation message, and may provide a list of conversation messages to which the favorites function has been applied through a favorites page. Here, the favorites page may be a dedicated interface that provides detailed operations and functions related to the favorites function. The favorites page may be provided within a chat room or may be provided through an independent interface outside a chat room. For example, the favorites page may provide a list of conversation messages to which the favorites function has been applied for each chat room or for all chat rooms.

The favorites function may be a function of supporting users to add important or frequently used conversation messages to a separate list and easily view and manage the same. That is, a user may apply the favorites function to not only conversation messages generated by the user, but also conversation messages generated by other users and shared through a chat room.

For example, the message management unit 390 may provide a favorites menu on the detailed view page for each conversation message, and the user may select the favorites menu and add a conversation message to a favorites list. The message management unit 390 may store the favorites list in association with the user account. The message management unit 390 may provide the favorites list to the user terminal 110 through various interfaces.

In addition, the message management unit 390 may sort the favorites list according to various criteria such as the order of recent addition, the order of title, and the order of date, and may selectively remove a conversation message desired by the user from the favorites list. The message management unit 390 may manage important conversation messages through a separate favorites list for each chat room or for all chat room. The message management unit 390 may provide a function of sharing the favorites list with other users, provide a tag function for the favorites list, and provide a notification to the user when a conversation message added to the favorites list is updated.

In an embodiment, the message management unit 390 may assign a status value indicating a specific status to each conversation message and store the same. Here, the function of managing a status value of a conversation message may be a function of assigning information indicating a specific status to the conversation message and managing the same. That is, a status value of a conversation message may be information indicating the progress, completion, importance, etc. associated with the conversation message as a separate function distinct from the tag.

For example, a status value of a conversation message may be used to indicate the progress of a task associated with the conversation message, such as ‘new’, ‘in progress’, ‘done’, and ‘checking’. As another example, a status value of a conversation message may be used to indicate the importance of the conversation message, such as ‘high’, ‘medium’, and ‘low’. The user may directly assign, modify, and delete a status value on the detailed view page of a conversation message, and the message management unit 390 may track the progress associated with the conversation message and automatically update the status value.

In an embodiment, the message management unit 390 may generate a recommended task list including selection options for each recommended task and provide the same to the user terminal 110. Here, the selection options may be functions that are activated according to user's selection for each of one or more recommended tasks. For example, the selection options may be implemented as checkboxes. That is, the recommended task list may be a list of recommended tasks and may be expressed as a set of pairs of recommended tasks and selection options. Accordingly, the user may individually select a recommended task through each selection option on the recommended task list. The message management unit 390 may generate a recommended task list as a response to a request for recommendation of tasks and provide the same to the user terminal 110, and the recommended task list may be displayed through a dedicated interface implemented on the user terminal 110.

In an embodiment, the message management unit 390 may remove a specific recommended task from the recommended task list if a task is created for the specific recommended task. For example, in a case where recommended tasks A and B associated with a specific conversation message are generated and recommended, if a task for recommended task B is generated by the user, the recommended task B can be removed from the recommended task list.

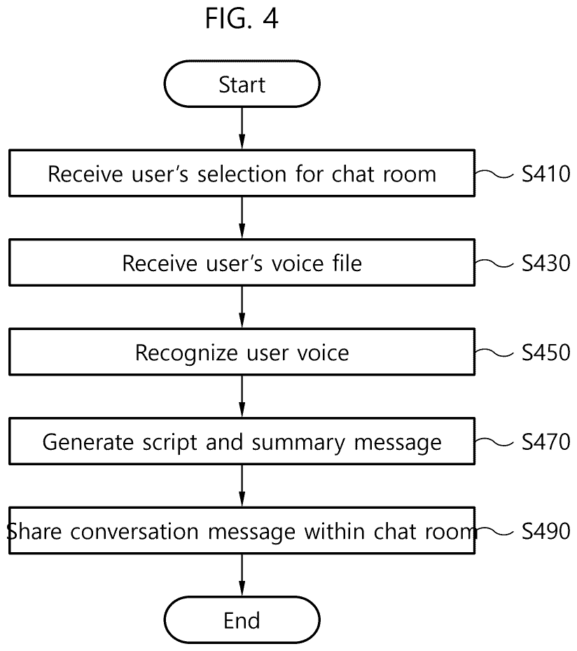

FIG. 4 is a flowchart illustrating an artificial intelligence-based message generation method according to the present disclosure.

Referring to FIG. 4, the message generation device 130 may receive a user's selection for a chat room from the user terminal 110 through the chat room selection unit 310 (step S410). The message generation device 130 may receive a user's voice file recorded on the user terminal 110 through the user voice reception unit 330 (step S430).

The message generation device 130 may recognize the voice of the voice file through the user voice recognition unit 350 (step S450), and generate a script converted into text and a summary message from the recognized voice (step S470). The message generation device 130 may display the summary message as a conversation message in the chat room associated with the user's selection through the conversation message sharing unit 370 (step S490).

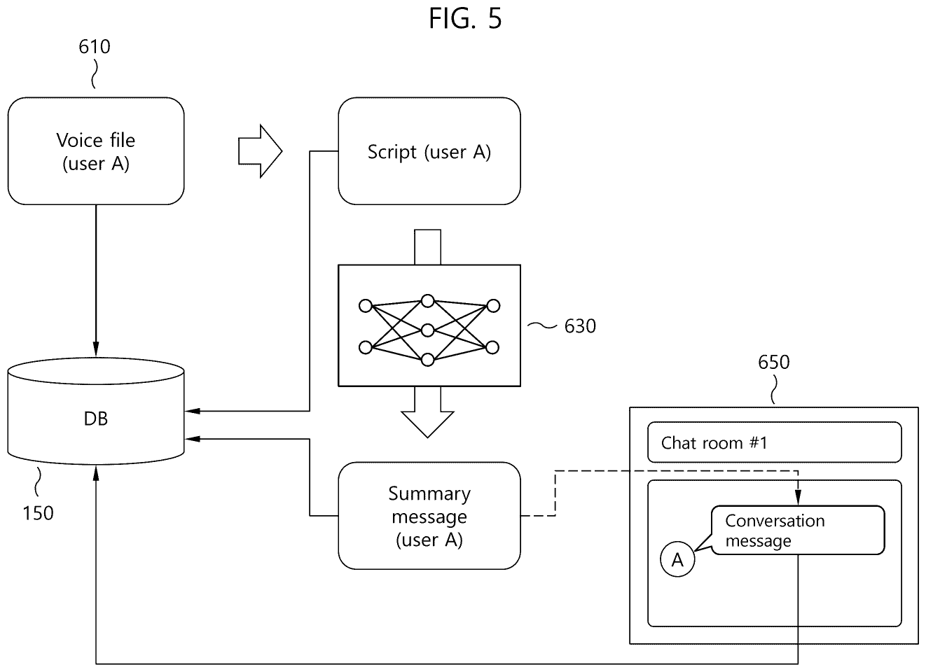

FIG. 5 is a diagram illustrating an embodiment of a process of generating a conversation message according to the present disclosure.

Referring to FIG. 5, the message generation device 130 may receive a voice file 610 of user A recorded on the user terminal 110. The message generation device 130 may recognize the voice of the voice file and generate a script converted into text and a summary message. At this time, the summary message may be generated based on the script and may be generated through an artificial intelligence model 630 constructed in advance. That is, the artificial intelligence model 630 may be designed to receive a script as input and output a summary message summarizing the details of the text of the script. The message generation device 130 may display the summary message as a conversation message in a chat room 650 associated with user's selection.

In addition, the message generation device 130 may store the script, the summary message, and the conversation message associated with the voice file 610 of user A in the database 150 and manage the same. The message generation device 130 may provide a voice file, a script, and a summary message associated with a conversation message by searching the database 150 when the conversation message is selected in the chat room 650.

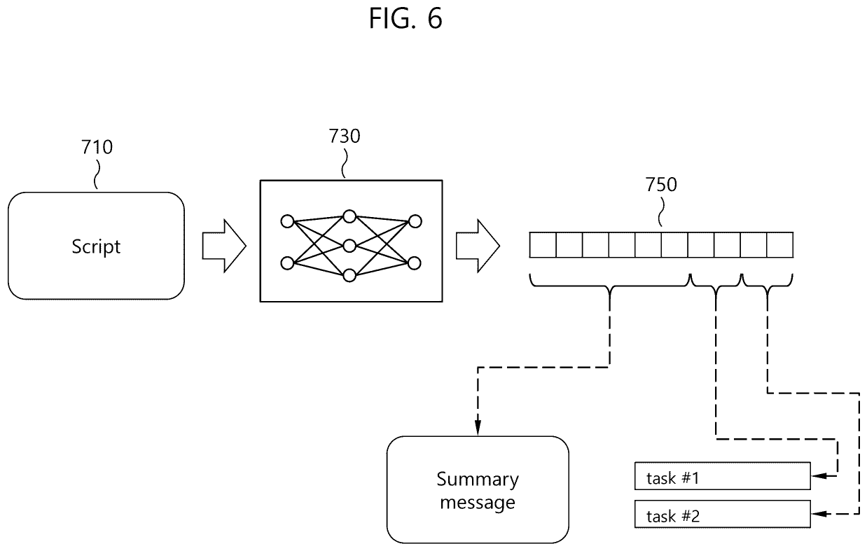

FIG. 6 is a diagram illustrating an embodiment of a task generation process according to the present disclosure.

Referring to FIG. 6, when the message generation device 130 receives a voice file in which details of work are recorded, the message generation device 130 may generate a summary message and a recommended task through an artificial intelligence model 730 using a script 710 extracted from the voice file. The message generation device 130 may provide the script 710 regarding the details of work as input to the artificial intelligence model 730, and may generate a summary message and a recommended task from the output of the artificial intelligence model 730.

The artificial intelligence model 730 may be constructed in advance based on a language model that receives text-type input and generates text-type output. The output of the artificial intelligence model 730 may be generated in the form of an output vector 750 having a dimension of a specific size, and the message generation device 130 may generate a summary message and one or more tasks task #1, #2, . . . using each component data of the output vector 750. I addition, if necessary, the input of the artificial intelligence model 730 may also be converted into vector data extracted from the script 710.

In an embodiment, the artificial intelligence model 730 may be implemented as a set of independent sub-models that generate a summary message and at least one recommended task. For example, the artificial intelligence model 730 may be designed as a model that transfers input data to sub-models and integrates the outputs of the sub-models to generate one piece of output data.

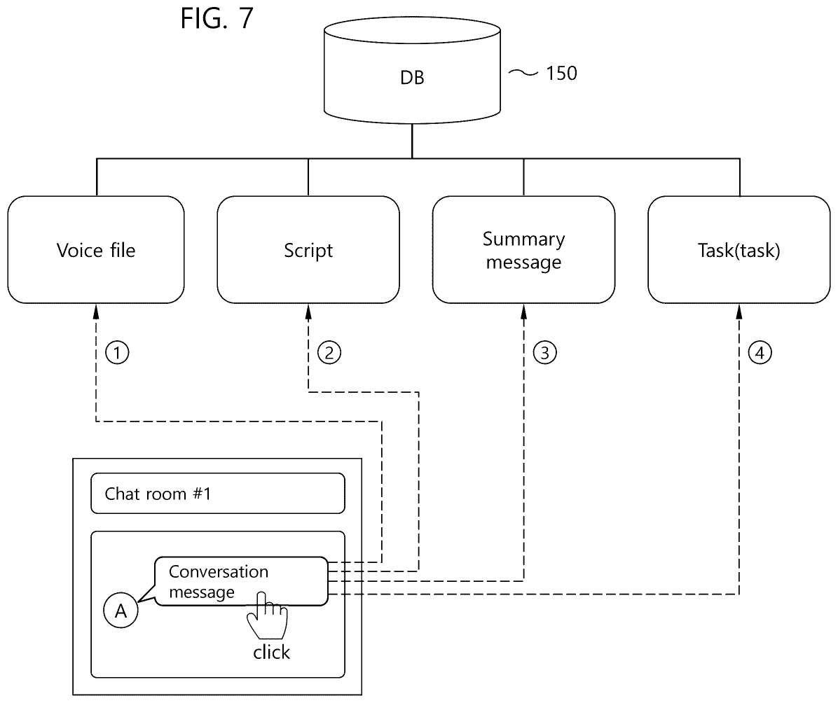

FIG. 7 is a diagram illustrating an embodiment of a process of providing related functions in a chat room according to the present disclosure.

Referring to FIG. 7, when the message generation device 130 receives a selection for a conversation message from a chat room participant in a chat room, the message generation device 130 may display an interface associated with the conversation message. In this case, the interface may include functions associated with the conversation message. For example, functions such as (1) listening to a voice file, 2 viewing a script, 3 viewing a message, and 4 creating a task may be provided through the interface, and the user may access concerned contents by selecting a specific function. The message generation device 130 may access the database 150 to retrieve data associated with the user's selection and then provide the data through the user terminal 110.

In addition, the message generation device 130 may restrict provision of the interface if the user participating in the chat room does not have access rights to the conversation message. That is, if a conversation message is selected by a user without access rights, the message generation device 130 may not perform an operation of providing an interface according to message selection. To this end, the message generation device 130 may set access rights for a conversation message related to a summary message when displaying the conversation message through a chat room.

That is, when the message generation device 130 displays a summary message extracted through a user's voice file as a conversation message in a chat room, the message generation device 130 can grant access rights preset by the user. For example, when the user records his or her own voice and shares the same as a conversation message through a chat room, the user may set restriction on access by other users in the chat room, and the message generation device 130 may revoke access rights of other users while displaying the conversation message in the chat room.

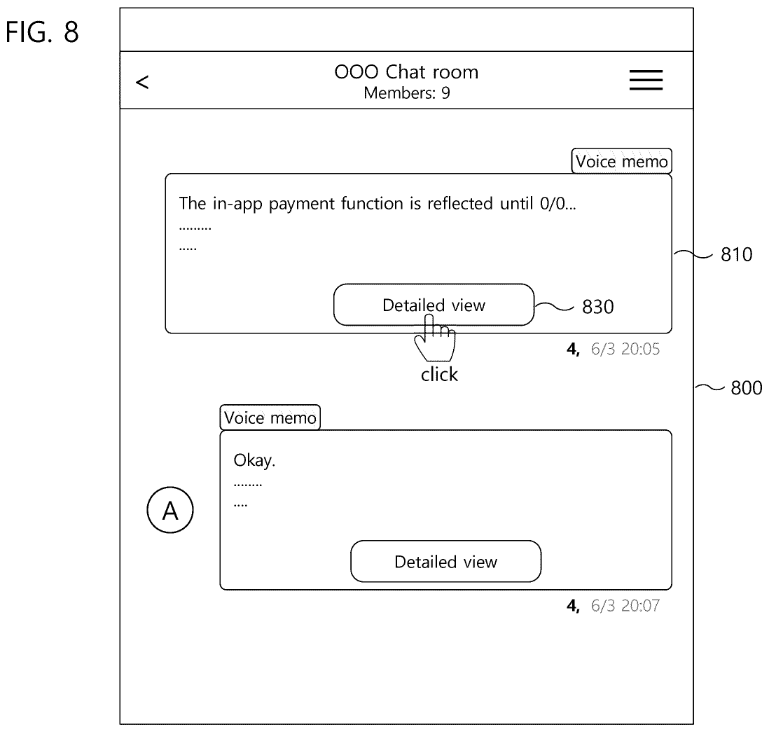

FIG. 8 is a diagram illustrating a process of sharing a conversation message regarding user's voice in a chat room according to the present disclosure.

Referring to FIG. 8, the message generation device 130 may share a conversation message 810 generated from a user's voice file through a chat room 800. In an embodiment, the conversation message 810 generated as a result of recognizing the user's voice may be displayed as a “voice memo” in the chat room 800. That is, the voice memo may include a result of converting the user's voice into text and summarizing the text, and may be displayed in the form of the conversation message 810 in the chat room 800.

In addition, the message generation device 130 may provide a detailed view page for the conversation message 810 while displaying the conversation message 810 through the chat room 800. To this end, the message generation device 130 may provide a detailed view menu 830 along with the conversation message 810.

That is, the user may access the detailed view page that provides details of the conversation message 810 by selecting (e.g., clicking) the detailed view menu 830 of the conversation message 810. For example, at least one of a voice file, a script, and a summary message associated with the conversation message 810 may be provided on the detailed view page of the conversation message 810. Here, the voice file, the script, or the summary message provided through the detailed view page may be restricted from access by other users according to privacy settings set by the user who has created the conversation message 810.

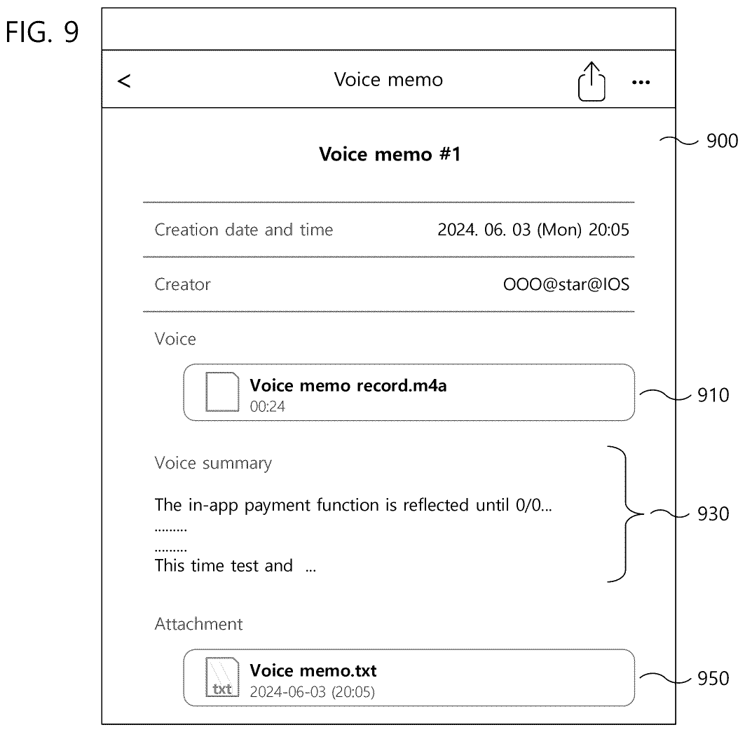

FIG. 9 is a diagram illustrating an embodiment of a detailed view page of a conversation message according to the present disclosure.

Referring to FIG. 9, the message generation device 130 may provide a detailed view page 900 for a conversation message. In an embodiment, a conversation message generated based on user's voice may be defined as a voice memo, and description will focus on the voice memo.

More specifically, the detailed view page 900 for the voice memo may be accessed by a user selecting the conversation message in the chat room. The detailed view page 900 may provide details related to the voice memo. For example, the detailed view page 900 may display the title (e.g., voice memo #1), creation date and time, and creator of the voice memo. In addition, the detailed view page 900 may display a user's voice file 910, a summary message 930, and a script 950 related to the voice memo.

The user may select the voice file 910 displayed on the detailed view page 900 to download the file, and check the contents of the summary message 930 and the script 950. If the length of the script 950 is long, the script 950 may be converted into a file format such as “voice memo recording.txt” and attached to the detailed view page 900. In addition, if the voice memo is set to private by the creator, other users without access rights may be restricted from downloading the voice file 910 set to private, display of the summary message 930 set to private may be restricted, and downloading of the attached file related to the script 950 set to private may be restricted.

Although preferred embodiments of the present disclosure have been described above, it will be understood by those skilled in the art that the present disclosure can be modified and changed in various manners within the scope of the spirit and scope of the present disclosure described in the following claims.

### DETAILED DESCRIPTION OF MAIN ELEMENTS

100: message generation system
110: user terminal
130: message generation device
150: database
210: processor
230: memory
250: user input/output unit
270: network input/output unit
310: chat room selection unit
330: user voice reception unit
350: user voice recognition unit
370: conversation message sharing unit
390: message management unit

What is claimed is:

1. A message generation device based on artificial intelligence, comprising:
a memory; and
a processor electrically connected to the memory,
wherein the processor is configured to:
receive selection of a user for a chat room from a user terminal;
receive a voice file of the user recorded on the user terminal;
recognize a voice of the voice file and generate a script converted into text and a summary message; and
display the summary message as a conversation message in the chat room associated with the selection of the user.

2. The message generation device of claim 1, wherein the processor is configured to receive a voice of the user input in a streaming manner from the user terminal in real time and generate the voice file.

3. The message generation device of claim 1, wherein the processor is configured to generate the script by applying a speech-to-text (STT) algorithm to the voice file and generate the summary message by inputting the script to an artificial intelligence model constructed in advance.

4. The message generation device of claim 1, wherein the processor is configured to generate the script and the summary message by inputting the voice file to an artificial intelligence model constructed in advance.

5. The message generation device of claim 4, wherein the artificial intelligence model is constructed by being trained to receive the voice file as input and generate at least one of the script or the summary message as output.

6. The message generation device of claim 1, wherein the processor is configured to display an interface associated with the conversation message based on reception of selection for the conversation message from a chat room participant of the chat room.

7. The message generation device of claim 6, wherein the processor is configured to provide at least one of a plurality of functions including viewing a script, listening to a voice file, and creating a task associated with the conversation message through the interface.

8. The message generation device of claim 6, wherein the processor is configured to, in a case where a task associated with the conversation message is generated through the interface, calculate a statistical value associated with the task and update the conversation message by adding the statistical value to the conversation message.

9. The message generation device of claim 1, wherein the processor is configured to:
identify a conversational tone of the voice in the process of recognizing the voice; and
convert the summary message into a conversation message to which the conversational tone has been applied in the process of displaying the summary message as the conversation message.

10. The message generation device of claim 1, wherein the processor is configured to generate at least one of the script or the summary message by applying the conversational tone of the voice identified in the process of recognizing the voice.

11. The message generation device of claim 9, wherein the processor is configured to update at least one of conversation messages displayed in the chat room with the conversational tone set by the user and display the updated conversation message.

12. The message generation device of claim 1, wherein the processor is configured to:
generate a tag associated with the summary message and combine the tag with the summary message; and
provide a search function for the summary message through the tag.

13. The message generation device of claim 1, wherein the processor is configured to selectively provide a message translation function in a process of providing details of the summary message.

14. The message generation device of claim 1, wherein the processor is configured to:
recommend one or more recommended tasks related to the summary message or the conversation message through a task recommendation model; and
generate a task related to a recommended task selected by the user from among the one or more recommended tasks.

15. The message generation device of claim 14, wherein the processor is configured to:
determine a work relevance regarding whether the summary message or the conversation message is related to details of work; and
generate a recommended task related to the details of work based on the work relevance exceeding a preset threshold value.

16. The message generation device of claim 1, wherein the processor is configured to, during a process of providing at least one of a voice file, a script, or a summary message related to the conversation message through a detailed view page for the conversation message, block other users from viewing the voice file, the script, or the summary message according to privacy setting set by the user.

17. The message generation device of claim 1, wherein the processor is configured to perform an operation of regenerating the summary message depending on the length of the summary message.

18. The message generation device of claim 1, wherein the processor is configured to:
assign a favorites function to each conversation message and store the conversation message; and
provide a list of conversation messages to which the favorite function has been assigned through a favorites page.

19. The message generation device of claim 1, wherein the processor is configured to assign a status value indicating a specific status to each conversation message and store the conversation message to which the status value has been assigned.

20. A method performed in a message generation device including a memory and a processor electrically connected to the memory, the method, performed by the processor, comprising:
receiving selection of a user for a chat room from a user terminal;
receiving a voice file of the user recorded on the user terminal;
recognizing a voice of the voice file and generating a script converted into text and a summary message; and
displaying the summary message as a conversation message in the chat room associated with the selection of the user.
